(19) United States
(12) Patent Application Publication
(10) Pub. No.: US 2010/0185943 A1
(43) Pub. Date: Jul. 22, 2010

(54) COMPARATIVE DOCUMENT SUMMARIZATION WITH DISCRIMINATIVE SENTENCE SELECTION

(75) Inventors: Dingding Wang, Miami, FL (US); Shenghuo Zhu, Santa Clara, CA (US); Tao Li, Coral Gables, FL (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/629,046

(22) Filed: Dec. 2, 2009

Related U.S. Application Data
(60) Provisional application No. 61/146,074, filed on Jan. 21, 2009.

(51) Int. Cl. G06F 17/21

(52) U.S. Cl. 715/254

(57) ABSTRACT

Systems and methods are disclosed for summarizing a plurality of documents, by extracting sentence candidates from the documents; dividing the documents into one or more groups; selecting one or more discriminant sentences for each group using a discriminant criterion; and generating one or more summaries for the one or more groups based on the selected sentences.

The present application claims priority to U.S. Provisional Application Ser. No. 61/146,074 and filed on Jan. 21, 2009, the content of which is incorporated by reference.

### BACKGROUND

The present application relates to systems and methods for summarizing documents.

Document summarization is a fundamental tool for document understanding and has been receiving much attention in recent years. With the explosive increase of documents on the Internet, document summarization plays more and more important roles in document understanding. Traditional document summarization aims to extract the major information in document collections, however, there exists a great necessity to compare different documents in many applications.

Most existing research efforts on document summarization focus on generating a compressed summary delivering the major information of the original documents. However, in many applications, when facing a set of document collections sharing similar topics, people are interested to know the differences in these documents. Thus instead of a generic summary, a summary describing major differences among the given documents is needed to facilitate the comparison of these document collections. For example, there are many recent news articles reporting President Obama's inaugural speech, however, different reports may have different focuses (e.g. some focus on his plan to restore economic growth, some focus on the politics, and there even be some articles mainly discuss his dress during the inauguration). The news summaries created by traditional summarization methods would all report that President Obama was inaugurated and gave an inauguration speech, however, the different points of view in these articles are also of great interests. Another example is comparing different blog communities and finding the changes in the community evolution. For example, the blogs in a blog community discussing hurricane Katrina change from the preparation before the hurricane, the damage of the hurricane to the recovery after the hurricane. The goal of traditional multi-document summarization is to generate a summary delivering the major information expressed in a collection of documents. Current methods usually ranks the sentences in the documents according to the scores calculated by a set of predefined features. In addition, graph-ranking based methods have been applied through the construction of a sentence graph, where the nodes represent the sentences in the document collection and the edges describe the pairwise relationships between corresponding sentences. The sentences are selected to form the summaries by voting from their neighbors. However, conventional system cannot summarize the changes/differences in different phases of the event.

Other works have focused on comparing documents. Natural language processing methods have been used to identify opinion words in the reviews and categorize them into positive and negative features. Then opinion sentences are predicted using these features and ranked based on their frequency. Finally, top ranking sentences are selected to form the summaries straightforwardly. Although the summaries consists of positive/negative sentences, the essence of the work is still based on word-level opinion mining. An approach called comparative text mining (CTM) identifies common and specific themes in multiple documents using a generative probabilistic mixture model. The results are listed in a comparison table and keywords are selected to represent the common/specific characteristics of the documents. However, word-level representation has limited interpretation ability and is difficult to understand.

### SUMMARY

In one aspect, systems and methods are disclosed for summarizing a plurality of documents, by extracting sentence candidates from the documents; dividing the documents into one or more groups; selecting one or more discriminant sentences for each group using a discriminant criterion; and generating one or more summaries for the one or more groups based on the selected sentences.

In another aspect, systems and methods are disclosed for summarizing a plurality of documents by extracting sentence candidates from the documents; generating a sentence-sentence similarity matrix; selecting discriminant sentences based on the sentence-sentence similarity matrix; and generating one or more summaries from the selected sentences.

Implementations of the above aspects may include one or more of the following. The system can generate a sentence-document similarity matrix. The system can determine document-sentence and sentence-sentence similarity matrices using cosine similarity. Each document is labeled to indicate cluster membership. The sentences can be selected one by one to minimize average variance of cluster targets. The system can perform the following:
a) creating a matrix K as [X,Y]′ [X, Y]+λ diag(W,I), where [X,Y] comprises a matrix by concatenating X and Y, [X,Y]′ comprises a transposed matrix, diag(W,I) comprises a block diagonal matrix with W and identity matrix I; and λ comprises a predetermined parameter; and
b) selecting a sentence i by maximizing K(i)′K(i)/K(i,i), where K(i) comprises an i-th column of matrix K; and
c) updating K as K-K(i)K(i)′/K(i,i); and
d) repeating b) and c) for a predetermined number of sentences.

In another aspect, a system performs discriminative sentence selection (DSS) based on a multivariate normal generative model to extract sentences best describing the unique characteristics of each document group. In one implementation, given a collection of document groups (clusters), the system decomposes these documents into sentences, and determines sentence-document and sentence-sentence similarities using cosine similarity. Since each document is labeled to indicate which cluster it belongs to, the system selects sentences one by one to minimize the average variance of all the cluster targets under the distribution estimation based on a multivariate normal generative model. Evaluation on various text data demonstrates the effectiveness and the discriminative ability of the summaries generated by the system. The system directly analyzes sentence features by taking into account the sentence-document and sentence-sentence relationships and the most discriminative sentences are selected to minimize the average variance of the group prediction.

Advantages of the preferred embodiments may include one or more of the following. The system provides accurate summaries of differences between document groups. The DSS method is used to extract the most discriminative sentences which represent the specific characteristics of each document group.

### BRIEF DESCRIPTION OF THE DRAWINGS

FIG. 1 shows an exemplary process to automatically determine the summary sentences with distinguishing topics from document groups.

FIG. 2 shows an exemplary process to generate a similarity matrix in FIG. 1.

FIG. 3 shows an exemplary system for performing comparative document summarization.

FIG. 4 shows a block diagram of a computer to support the system.

### DESCRIPTION

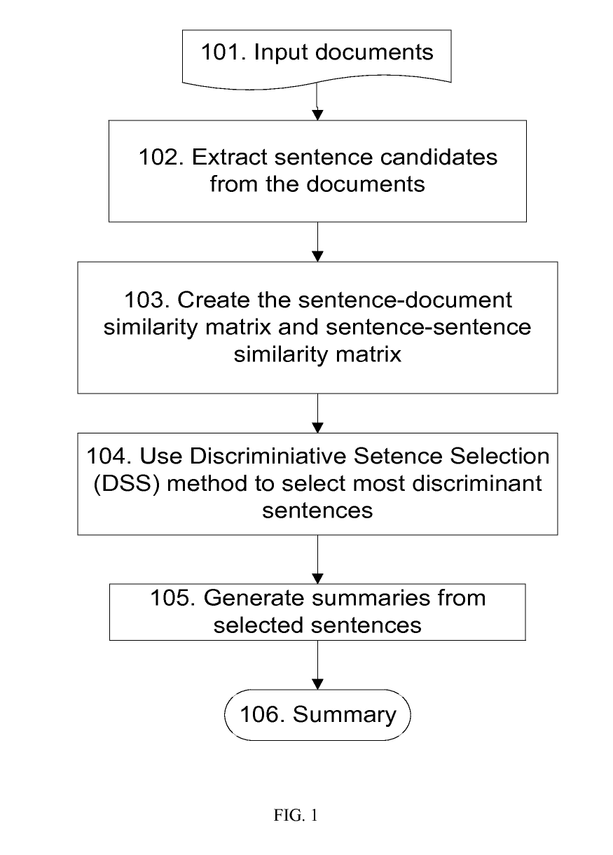

FIG. 1 shows an exemplary process to automatically determine the summary sentences with distinguishing topics from document groups. The process uses Comparative Extractive Document Summarization (CDS) to summarize the differences between comparable document groups. In one embodiment, given a collection of document groups, CDS can generate a short summary showing the differences of these documents by extracting the most discriminative sentences in each document group. This is done by finding differences among document collections.

In one implementation, the system finds solution to CDS by sequentially selecting sentences from the documents by a greedy approach which minimizes the remaining uncertainty (entropy) of the documents after extracting sentences one by one based on the empirical distribution estimation. However, the empirical distribution faces data sparseness problem.

In the preferred embodiment, the system performs discriminative sentence selection based on a multivariate normal generative model to extract sentences best describing the unique characteristics of each document group. As shown in FIG. 1, the process receives a plurality of input documents in 101. Using the input documents, the process produces comparative summaries of document groups by selecting predetermined sentences from original documents. In 102, the process extracts sentences from the documents received in 101. The documents are split into sentences. Only those sentences suitable for summary are selected as the sentence candidates.

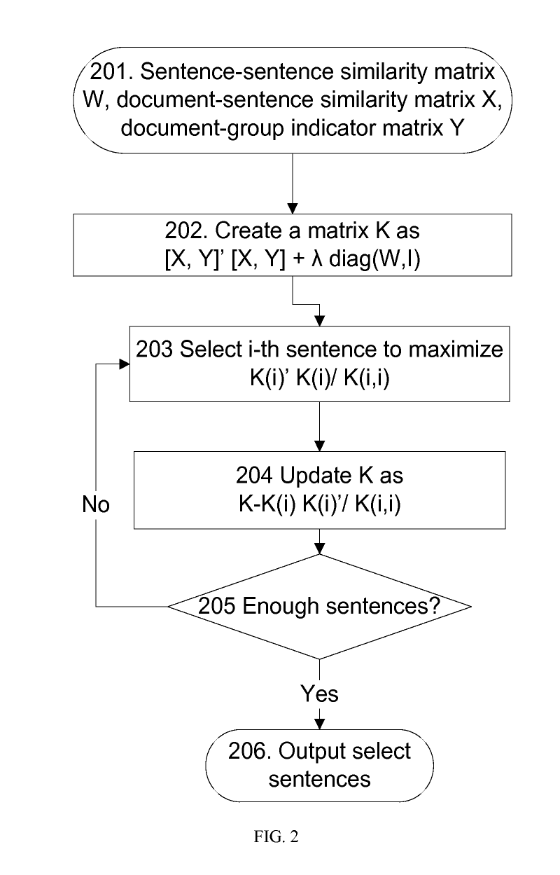

Next, in 103, the process determines the similarity between the candidate sentences and the similarity between sentences and documents and generate a similarity matrix W. In 104, the process selects the sentence following the procedure as detailed in FIG. 2. The selected sentences can efficiently render distinct the documents from different document groups.

In 105, the summaries are formed with sentences selected in 104. Thus, the process extracts sentences and determines distinguishing features for different document groups. The system directly analyzes sentence features by taking into account the sentence-document and sentence-sentence relationships and the most discriminative sentences are selected to minimize the average variance of the group prediction.

The process then generates summaries as outputs in 106. The comparative summaries are of high quality in term of the capability in comparing document groups. There are various applications of CDS, for example, comparing different news groups, finding differences between communities in social network, among others.

In brief, given a collection of document clusters, the process of FIG. 1 decomposes the documents into sentences, and determines document-sentence and sentence-sentence similarities using cosine similarity, for example. Since each document is labeled to indicate which cluster it belongs to, the process can select sentences one by one to minimize the average variance of all the cluster targets.

One exemplary pseudo-code for the process of FIG. 1 is as follows:

Input: X: document-sentence similarity matrix,
Y: document group indicator,
W: sentence-sentence similarity matrix,
m: predefined number of selected sentences,
λ: regularization parameter;
Output: S: selected sentences;

| 1: S = ; | |
|---|---|
| 2: Z = [X, Y]; | |
| 3: K = Z λ Z + λ diag(W,I); | |
| 4: repeat | |
| 5: | i = arg max K_{iT}K_{Ti}/Kᵢᵢ; |

i∈F − S

| | |
|---|---|
| 6: | K ← K − (K_{.i}K_{i.})/Kᵢᵢ; |
| 7: | S ← S ∪ {i}; |

8: until |S| = m.

Turning now to FIG. 2, operation 104 of FIG. 1 is shown in more detail. In 201, the input of this process is a sentence-sentence similarity matrix W from 103, and the document-sentence similarity matrix X from 103, document-group indicator matrix Y. In 202, the process creates a matrix K as [X,Y]′ [X, Y]+λ diag(W,I), where [X,Y] is the matrix by concatenating X and Y, [X,Y]′ is its transposed matrix, diag(W,I) is the block diagonal matrix contains W and identity matrix I. Parameter λ can be user specified.

In 203, the process selects a sentence i by maximize K(i)′K(i)/K(i,i), where K(i) is the i-th column of matrix K. K(i,i) is the element of K on i-th column and i-th row. In 204, the process updates K as K-K(i)K(i)′/K(i,i). In 205, the process repeats 203 and 204 until the required number of sentences is obtained. In 206, the process returns the selected sentences as the output.

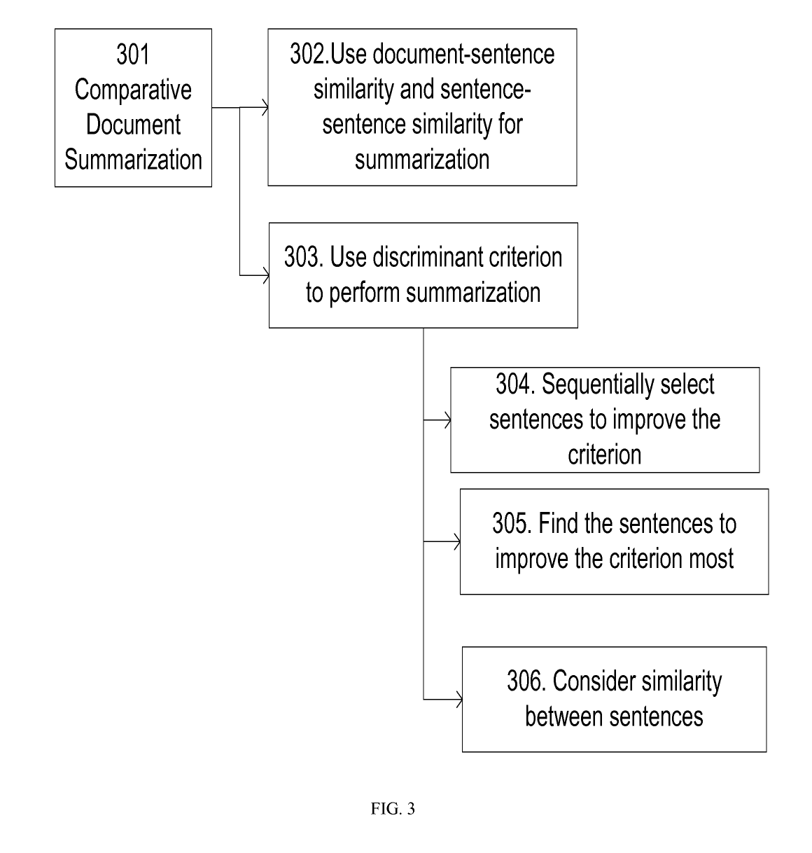

FIG. 3 shows an exemplary system for performing comparative document summarization. In 301, the system includes a means for summarizing the content of documents by considering a discrimant criterion. In 302, the system uses document-sentence similarity and sentence-sentence similarity to perform the summarization task. In 303, one embodiment uses a discriminant criterion for sentence selection. The criterion measures the capability to predict the document group based on similarity between document and selected group summaries. In 304, the system sequentially selects sentences to improve the criterion. In 305, the system uses an efficient means to find the sentences to improve the criterion most. In one embodiment, in 306, the criterion includes the similarity between sentences to avoid redundancy.

The system produces comparative summaries of document groups by selecting sentences from original documents. The selected sentences can render efficiently distinct the documents from different document groups. The comparative summaries have higher quality in term of the capability in comparing document groups. The system can be used in a variety of application, for example, comparing different news groups, finding differences between communities in social network, among others.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

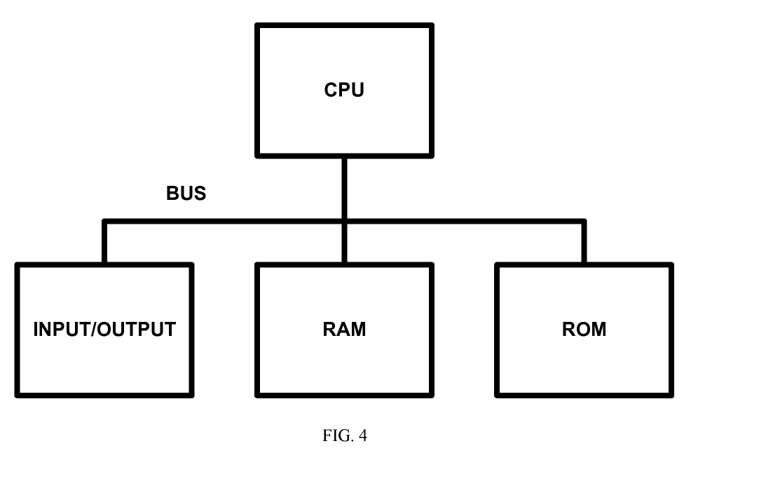

By way of example, FIG. 4 shows a block diagram of a computer to support the system. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method for summarizing a plurality of documents, comprising:
a. extracting sentence candidates from the documents;
b. generating a sentence-sentence similarity matrix;
c. selecting discriminant sentences based on the sentence-sentence similarity matrix; and
d. generating one or more summaries from the selected sentences.

2. The method of claim 1, comprising generating a sentence-document similarity matrix.

3. The method of claim 2, comprising determining the document-sentence and sentence-sentence similarity matrices using cosine similarity.

4. The method of claim 1, comprising labeling each document to indicate cluster membership.

6. The method of claim 1, comprising selecting sentences one by one to minimize average variance of cluster targets.

7. The method of claim 1, comprising:
a) creating a matrix K as [X,Y]′ [X, Y]+λ diag(W,I), where [X,Y] comprises a matrix by concatenating X and Y, [X,Y]′ comprises a transposed matrix, diag(W,I) comprises a block diagonal matrix with W and identity matrix I; and λ comprises a predetermined parameter; and
b) selecting a sentence i by maximizing K(i)′K(i)/K(i,i), where K(i) comprises an i-th column of matrix K; and
c) updating K as K-K(i)K(i)′/K(i,i); and
d) repeating b) and c) for a predetermined number of sentences.

8. A method for summarizing a plurality of documents, comprising:
a. extracting sentence candidates from the documents;
b. dividing the documents into one or more groups;
c. selecting one or more discriminant sentences for each group using a discriminant criterion; and
d. generating one or more summaries for the one or more groups based on the selected sentences.

9. The method of claim 8, wherein the discriminant criterion measures a capability to predict each document group based on similarity between document and selected group summaries.

10. The method of claim 8, comprising sequentially improving the criterion by selecting the discriminant sentences.

11. The method of claim 8, wherein the discriminant criterion comprises measuring similarity between sentences to avoid the redundancy.

12. The method of claim 8, comprising:
a) creating a matrix K as [X,Y]′ [X, Y]+λ diag(W,I), where [X,Y] comprises a matrix by concatenating X and Y, [X,Y]′ comprises a transposed matrix, diag(W,I) comprises a block diagonal matrix with W and identity matrix I; and λ comprises a predetermined parameter; and
b) selecting a sentence i by maximizing K(i)′K(i)/K(i,i), where K(i) comprises an i-th column of matrix K; and
c) updating K as K-K(i)K(i)′/K(i,i); and
d) repeating b) and c) for a predetermined number of sentences.

13. A system for summarizing a plurality of documents, comprising:
a. means for extracting sentence candidates from the documents;
b. means for dividing the documents into one or more groups;
c. means for selecting one or more discriminant sentences for each group using a discriminant criterion; and
d. means for generating one or more summaries for the one or more groups based on the selected sentences.

14. The system of claim 13, wherein the discriminant criterion measures a capability to predict each document group based on similarity between document and selected group summaries.

15. The system of claim 13, comprising means for sequentially improving the criterion by selecting the discriminant sentences.

16. The system of claim 13, wherein the discriminant criterion comprises measuring similarity between sentences to avoid the redundancy.

17. The system of claim 13, comprising:
means for creating a matrix K as [X,Y]′ [X, Y]+λ diag(W,I), where [X,Y] comprises a matrix by concatenating X and Y, [X,Y]′ comprises a transposed matrix, diag(W,I) comprises a block diagonal matrix with W and identity matrix I; and λ comprises a predetermined parameter; and
means for selecting a sentence i by maximizing K(i)′K(i)/K(i,i), where K(i) comprises an i-th column of matrix K; and
means for updating K as K-K(i)K(i)′/K(i,i).

18. The system of claim 13, comprising means for determining the document-sentence and sentence-sentence similarity matrices using cosine similarity.

19. The system of claim 13, comprising means for labeling each document to indicate cluster membership.

20. The system of claim 13, comprising means for selecting sentences one by one to minimize average variance of cluster targets.
